(19) United States
(12) Patent Application Publication
(10) Pub. No.: US 2013/0193365 A1
(43) Pub. Date: Aug. 1, 2013

(54) Natural fiber insulation material and method for makingthe same

(71) Applicant: Mohamed El-Sayed Ali, Riyadh (SA)

(72) Inventor: Mohamed El-Sayed Ali, Riyadh (SA)

(21) Appl. No.: 13/364,309

(22) Filed: Feb. 1, 2012

(51) Int. Cl. E04B 1/78; B29C 43/22

(52) U.S. Cl. 252/62; 264/119

(57) ABSTRACT

Durable insulation materials, having combined properties of low thermal conductivity along with low water absorption/high water repellency are suitable for many applications such as insulation to buildings walls and air conditioning pipes and as insulation materials for durable electrical goods such as refrigerators and the insulation of metallic conducting wire. The current invention is a new and novel insulation material based resins and naturally occurring fibers found in plants such as Calotropis procera, a species of flowering plant in the Apocynaceae or dogbane family. The current invention proving to have similar or comparable thermal conductivity than commercially available building insulating material such as rockwool.

### FIELD OF INVENTION

The current invention is a new and novel insulation material that is particularly useful as an insulating material for applications such as insulation material for building walls and air conditioning pipework, and an insulation material for electrical durable goods and devices.

### BACKGROUND OF THE INVENTION

Durable insulation materials are very important in our everyday lives. These materials, having combined properties of low thermal conductivity along with low water absorption/high water repellency are suitable for many applications such as insulation to buildings walls and air conditioning pipes and as insulation materials for durable electrical goods such as refrigerators and the insulation of metallic conducting wire.

### SUMMARY OF THE INVENTION

The current invention is a new and novel insulation material based on the naturally occurring fibers found in plants such as Calotropis procera, a species of flowering plant in the Apocynaceae or dogbane family.

### BRIEF DESCRIPTION OF THE DRAWINGS

FIG. 1 is a graph showing the thermal conductivity of one embodiment of the current invention.

FIG. 2 is a graph showing the thermal conductivity of an alternative embodiment of the current invention.

FIG. 3 is a graph showing the thermal conductivity of the alternative embodiments of the current invention in comparison to a commercially available insulation board and an industry performance standard for insulation boards.

FIGS. 4 and 5 are images taken by a Transmission Electron Microscope (TEM) of the fibers from the seedpod of the Calotropis procera as used in an embodiment of the current invention.

### DETAILED DESCRIPTION OF THE INVENTION

The current invention is based on the advantages of using a new natural insulating material which is safe, has low water absorption and low thermal conductivity. In an embodiment of the current invention, the invention utilizes the fibers found in seed pods of the Calotropis procera plant.

Calotropis procera is a native species from south west of Asia and Africa that has been traditionally harvested for its medicinal properties to treat a variety of illness including leprosy, fever, menorrhagia, malaria, and snake bites. The species has also been successfully cultivated in the Caribbean Islands, Central and South America and South Africa and is known under various common names such as Giant milkweed, Sodom-apple, or ushar or ashkhar in Arabic. Calotropis procera normally grows in dry habitat (6 to 39 inches (150 to 1000 mm) annual precipitation) and sometimes in excessively drained soils in areas with as much as 79 inches (2000 mm) of annual precipitation. Calotropis procera has also been found in growing areas up to 3,280 feet (1000 meters) in elevation.

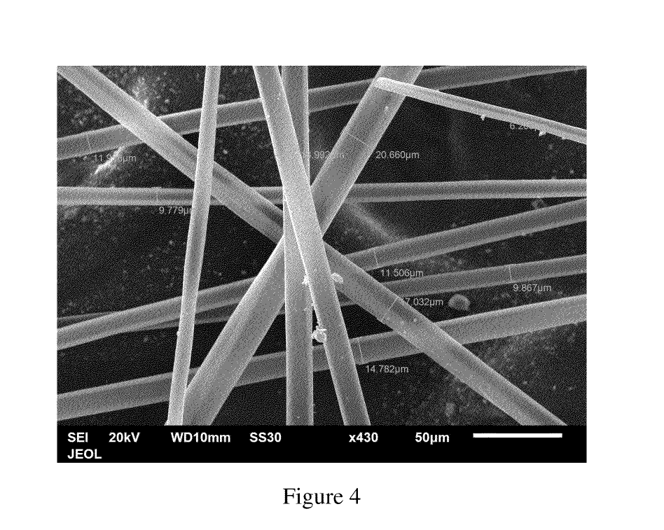

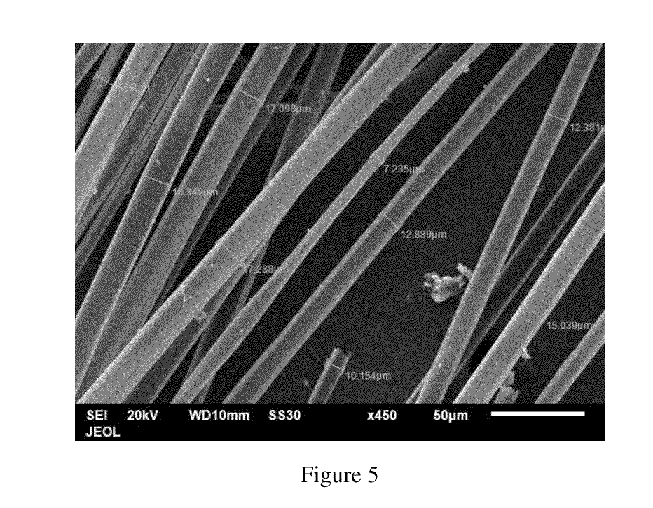

The current invention uses the long silky fibers present in the seed pods of Calotropis procera at maturity; when the seed pod is fruit grey-green in color, inflated, 8 to 12 cm in length, and contains numerous seeds with tufts of long silky fibers at one end of the seed pod. Further as shown in FIGS. 4 and 5, the maximum and minimum diameter of the fibers present in the seed pods of Calotropis procera are 20.66 μm and 5.56 μm respectively. It is these fibers that are used in an embodiment of the current invention once the seeds have removed from the fibers, and the fibers dried before further processing.

In an embodiment of the current invention, boards of insulating material were made using a phenolic-formaldehyde resin (Bakelite Resin 0421 M) to bind the dry fibers, with the board being compressed to a thickness of 0.9 inches (0.0235 meters) in a compressed box of size 11.8×11.8 inches (0.3×0.3 m²) and then put in an oven at 100° C. until vaporization of all water is completed and a dry insulation board is obtained.

In this embodiment of the current invention, starting with 6.9 ounces (196 grams) of dry fibers, the mass of the final dry insulation board was 8.0 ounces (227 grams); representing a 1.1 ounce (31 gram) increase in weight in the polymerization of the resin in the board. The density of the board was 6.69 lb/ft³ (107.17 kg/m³); representing a ratio of resin to dry fiber of 15.82%. A second board made of the same materials was also prepared and produced an insulating board with a density of 7.33 lb/ft³ (117.44 kg/m³) and having a resin ratio of 43.83%.

An alternative embodiment of the current invention produced dry fibrous insulation boards by using cornstarch resin to bind the dry fibers. In this embodiment of the current invention 5.3 ounces (151 grams) of dry fibers were saturated in a cornstarch resin using 14.2 ounces (403 grams) of cornstarch. After drying, the density of the cornstarch resin-based insulation board was 16.6 lb/ft³ (265.63 kg/m³) with cornstarch resin adding 191.4% by weight of the original dry fiber. A second insulation board using a cornstarch resin produced a board of a lower density of 8.14 lb/ft³ (130.47 kg/m³), with a resin ratio of 30.73% of the original fiber used.

Another alternative embodiment of the current invention produced dry fibrous insulation annulus which could be used for insulating the pipes by using cornstarch resin to bind the dry fibers. In this embodiment of 6.0 ounces (171 grams) of dry fibers were saturated in a cornstarch resin using 2.5 ounces (71 grams) of cornstarch to form a cylinder of insulating material with an outer diameter of 3.09 inches (7.85 cm) and an inner diameter of 0.9 inches (2.3 cm). After drying and polymerization of the cornstarch resin, which adding 19.3% by weight to the original dry fiber, the density of the cornstarch resin-based insulation cylinder was 9.93 lb/ft³ (159.00 kg/m³), with a total mass of 7.19 ounces (204 grams). Thermal Conductivity Test Methodology

The thermal conductivity of various boards, defined earlier, was measured using the Heat Flow Meter (HFM 436/3/1 Lambda) instrument manufactured and provided by NETZSCH-Geratebau Gmbh. The thermal conductivity test involves placing a sample of the test material being placed between two heated plates, which are set at different temperatures. A calibrated heat flux transducer measures the heat flow q through the sample. After reaching a thermal equilibrium, the test is done. Only the sample center (100×100 mm) is used for the analysis. The heat flux transducer output is calibrated with the standard. The magnitude of the heat flow q depends on the thermal conductivity of the sample k, thickness of the sample Ax, temperature difference across the sample AT and the area through which the heat flows A. Fourier's law of conduction gives the relation between these parameters:

$$\dot{Q} = k A \frac{Δ T}{Δ x}$$

One or two heat flow transducers (as provided by the manufacturer) measure the heat flow through the sample. The signal of a heat flow transducer (in volt) is proportional to the heat flow through the transducer. In the HFM 436 Heat Flow Meter instrument, the area of the heat flow transducer represents the area through which the heat flows and is the same for all samples; therefore:

\dot{Q}=N V

Where N is the calibration factor that relates the voltage signal of the heat flow transducer to the heat flux through the sample. Solving the two above we derive the thermal conductivity, k:

$$k = \frac{N V}{A} \frac{Δ x}{Δ T}$$

As provided by the manufacturer, the heat flow meter method is a standardized test technique for measuring the thermal conductivity of insulating materials following the standards ISO 8301, ASTM C518, DIN EN 12667/12939 and DIN EN 13163 respectively.

In testing the insulation sample size used by the instrument was 300×300 mm with a thickness between 5 to 100 mm. It should be noted that, the instrument was equipped with a transducer to read the thickness of the sample in cm and up to four decimals accuracy. The error in reading the thickness of the sample was ±0.0001 cm, in measuring the average temperature is ±0.01° C. and in measuring the thermal conductivity was ±0.000001 W/mK as provided by the manufacturer. The standard deviation of the thermal conductivity was 0.00004 as specified by the software of the instrument. The error in measuring the mass and the volume of the insulating boards was ±0.001 kg and ±7.6×10⁻⁶ m³ respectively. These errors lead to uncertainty in determining the density of samples was 1.44% at most.

### Thermal Conductivity Test Results

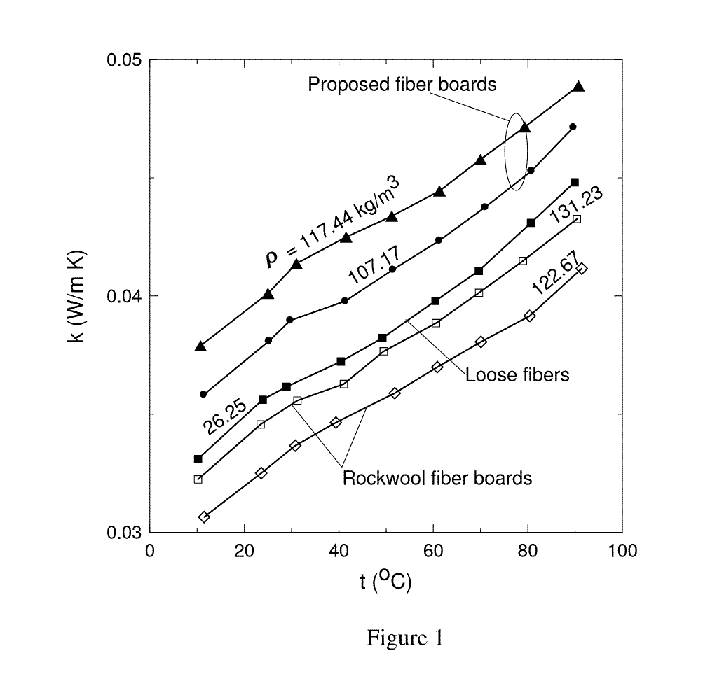

FIG. 1 is a graph showing the thermal conductivity of the two phenolic-formaldehyde resin-based fiber boards described above in comparison to two commercially available rockwool samples from Saudi Rock Wool Factory, Riyadh, K.S.A. which had densities of 7.66 lb/ft³ (122.67 kg/m³) and 8.19 lb/ft³ (131.23 kg/m³) respectively. As shown in FIG. 1 the two board embodiments of the current invention had insulating properties comparable to commercially available rockwool of a similar density.

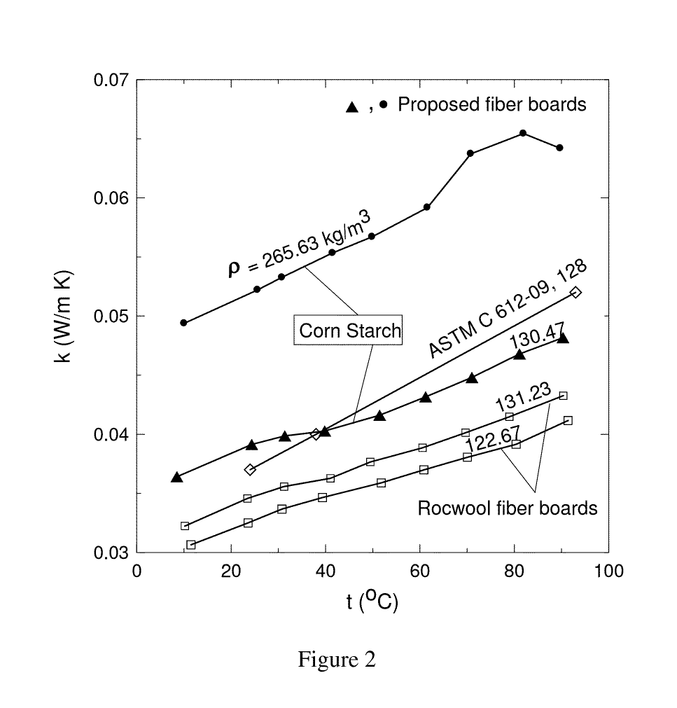

FIG. 2 is a graph showing the thermal conductivity of the two cornstarch resin-based fiber boards described above in comparison to commercially available rockwool of densities of 7.66 lb/ft³ (122.67 kg/m³) and 8.19 lb/ft³ (131.23 kg/m³).

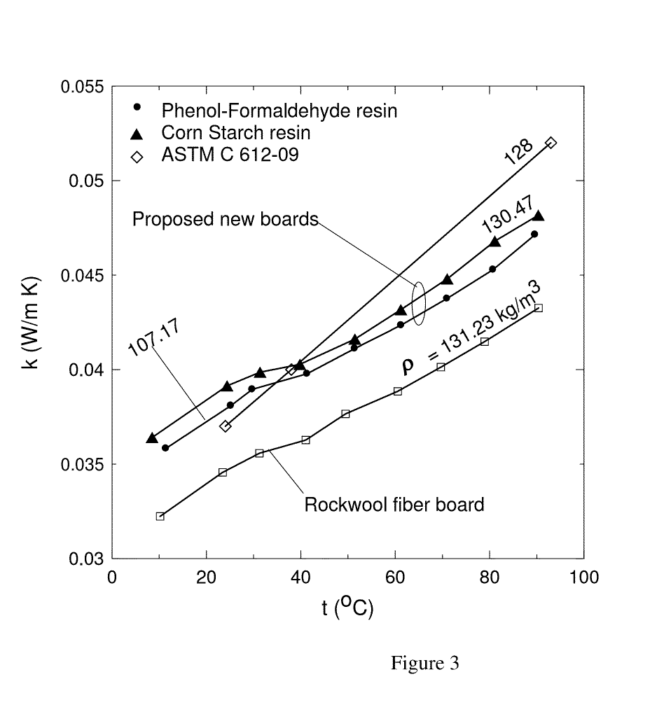

FIG. 3 is a graph showing the thermal conductivity phenolic-formaldehyde resin-based and cornstarch resin-based insulation boards in comparison to commercially available rockwool boards of comparable densities of 8.19 lb/ft³ (131.23 kg/m³) and the commercial performance standards for insulating boards and materials as given in ASTM C 612-09.

The results from FIGS. 1 to 3 show that using cornstarch-resin and phenolic-formaldehyde resin-based fiber boards are comparable to that of the two rockwool boards. However, using cornstarch as a binder is a promising future since it is an organic material and more safe for human beings. Results also show that the boards are as close to the ASTM standard than the rockwool boards. Therefore, it is suggested that the cornstarch can be used as a resin with different concentrations to make the new boards. It is also noted that as the density decreases the thermal conductivity decreases which means an enhancement effect of the insulating boards. The ratio of the resin to the dry fiber is found to be density dependent. Finally, using this new fiber as an insulating material turns to be a promising future when used either as loose fibers or as solid boards.

We claim:

1. An insulating material for applications such as insulation material for buildings and durable goods comprising fibers from seed pods from the flowering plants in the Apocynaceae or dogbane family and a resin binder such that the insulating material has a thermal conductivity coefficient between 0.03 to 0.07 W/mK.

2. An insulating material as in claim 1 wherein the insulating material has a density between 6.69 lb/ft³ and 16.6 lb/ft³.

3. An insulating material as in claim 1 wherein the flowering plant in the Apocynaceae or dogbane family is Calotropis procera.

4. An insulating material as in claim 1 wherein the thickness of the fibers are between 20.66 μm and 5.56 μm.

5. An insulating material as in claim 1 wherein the resin binder is a phenolic-formaldehyde resin.

6. An insulating material as in claim 1 wherein the resin binder is a cornstarch resin.

7. An insulating material as in claim 1 wherein the insulating material is used to insulate building walls or air conditioning pipework.

8. An insulating material as in claim 1 wherein the insulating material is used to insulate electrical durable goods and devices.

9. An insulating material as in claim 1 wherein the insulating material has a comparable density and thermal conductivity to that of commercially available rockwool.

10. A method for applications making insulation material for buildings and durable goods comprising mixing the fibers from seed pods from the flowering plants in the Apocynaceae or dogbane family with a resin binder, compressing the mixture to a thickness of between 0.5 to 1.5 inches, heating the mixture at a temperature between 80° C. to 120° C. until vaporization of all water is completed and a dry insulation board is obtained.

11. A method as in claim 10 wherein the insulating material has a thermal conductivity coefficient between 0.03 to 0.07 W/mK.

12. A method as in claim 11 wherein the insulating material has a density between 6.69 lb/ft³ and 16.6 lb/ft³.

13. A method as in claim 11 wherein the flowering plant in the Apocynaceae or dogbane family is Calotropis procera.

14. A method as in claim 11 wherein the thickness of the fibers are between 20.66 μm and 5.56 μm.

15. A method as in claim 11 wherein the resin binder is a phenolic-formaldehyde resin.

16. A method as in claim 11 wherein the resin binder is a cornstarch resin.

17. A method as in claim 11 wherein the insulating material is used to insulate building walls.

18. A method as in claim 11 wherein the insulating material is used to insulate air conditioning pipework.

19. A method as in claim 11 wherein the insulating material is used to insulate electrical durable goods and devices.

20. A method as in claim 11 wherein the insulating material has a comparable density and thermal conductivity to that of commercially available rockwool.
